(19) United States
(12) Patent Application Publication
(10) Pub. No.: US 2004/0043201 A1
(43) Pub. Date: Mar. 4, 2004

(54) Adhesive elements capable of being stacked without protection

(76) Inventors: Herve Durand, Dijon (FR); Stephane Auguste, Varois et Chaignot (FR); Maud Staeger, Dijon (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/343,640

(22) PCT Filed: Aug. 3, 2001
(86) PCT No.: PCT/FR01/02538

(30) Foreign Application Priority Data
Aug. 4, 2000 (FR) 00 10327

(51) Int. Cl. B32B 9/00

(52) U.S. Cl. 428/195.1; 428/40.1

(57) ABSTRACT

The present invention relates in general terms to novel adhesive elements capable of being stacked without protection, and to the process for their manufacture.

According to the invention, each adhesive element comprises a surface (2) provided with a pressure-sensitive adhesive and designed to be assembled to a substrate by bonding, said adhesive being present over at least part of said surface (2) and has a reduced adhesive capacity over part of the thickness of at least one portion of its free surface (4), defining a very slightly adhesive or non-adhesive film (5) enabling said element to be rolled up or stacked with other adhesive elements without protection, said film (5) also being capable of being broken under the effect of the pressure applied when said element is assembled to a substrate.

The invention applies especially to the manufacture of sealing panels for the motor vehicle industry.

The present invention relates in general terms to adhesive elements, especially in the form of strips or sheets, comprising a surface provided with a pressure-sensitive adhesive, and capable of being stacked without the intercalation of a non-stick protective sheet.

The invention applies particularly, but not exclusively, to the manufacture of sealing panels for motor vehicles.

### PRIOR ART

It is known that, if strips or sheets precoated with adhesive are to be stored efficiently in an industrial environment, especially in the motor vehicle industry, it is generally necessary to form rolls of strips or stacks of sheets which, because of the presence of an adhesive on at least one side, are likely to stick together and thereby become inseparable.

To avoid this risk, the simplest solution consists in placing a protective sheet, treated with a non-stick product, between successive adhesive sheets. The sheets precoated with adhesive are then easy to separate, but the additional presence of the non-stick sheet increases the manufacturing and application costs of these sheets and generates bulky waste in workshops.

Another conventional means of rolling up strips or stacking sheets precoated with adhesive on only one side consists in treating the non-adhesive side of this sheet with a non-stick component such as a siliconized coating. However, this-treatment increases manufacturing costs and rules out the possibility of fixing another adhesive object firmly to the treated side.

Moreover, patent U.S. Pat. No. 5,322,722 discloses a sealing panel provided with a thermoformed groove around its periphery, in which a thick adhesive is deposited and then covered with a flexible mesh; during storage, the mesh acts as a protective element between the stacked panels and, when the panel is placed on a substrate such as a vehicle, it is only necessary to press hard enough for the adhesive to pass through the mesh and adhere to the substrate.

Furthermore, patent U.S. Pat. No. 5,344,693 discloses an adhesive sheet whose adhesive surface carries non-adhesive bosses that are shaped to allow the sheet to be rolled up onto itself while avoiding direct contact between the adhesive layer and the non-adhesive side of the substrate of the bottom turn. In the embodiment shown in FIG. 5, each boss is formed of a localized overthickness of the layer of adhesive compound, said overthickness being covered with a piece of non-adhesive sheet. This involves coating the entire surface of the sheet, which is complicated to carry out and cannot be used to produce three-dimensional adhesive elements such as the sealing sheets in the doors of motor vehicles. Moreover, a large part of the adhesive layer remains accessible for unintentional contact, making it more difficult to use.

### OBJECT OF THE INVENTION

Under these conditions, one object of the present invention is to solve the technical problem that consists in the provision of a new design of adhesive elements which can be rolled up onto themselves or stacked together without the help of an additional protective element, and which are positioned easily and more precisely than existing elements.

Another object of the present invention is to solve the above-mentioned technical problem in a simple manner than can be implemented on an industrial scale.

### DESCRIPTION

According to a first feature, the solution according to the present invention for solving the above-mentioned technical problem consists of an adhesive element, especially in the form of a strip or sheet, comprising a surface provided with a pressure-sensitive adhesive and designed to be assembled on a substrate by bonding, characterized in that said adhesive is present over at least part of said surface, preferably in the form of a discontinuous layer, and in that it has a reduced adhesive capacity over part of the thickness of at least one portion of its free surface, defining a very slightly adhesive or non-adhesive film enabling said element to be rolled up or stacked with other adhesive elements without protection, said film also being capable of being broken under the effect of the pressure applied when said element is assembled to a substrate.

In a currently preferred embodiment of the invention, the slightly adhesive or non-adhesive film mentioned above is obtained by a surface crosslinking treatment of the pressure-sensitive adhesive, preferably a photoinduced crosslinking treatment.

Thus the novelty of the solution according to the invention is that the surface of the pressure-sensitive adhesive is treated locally in such a way as to significantly reduce its adhesive capacity so as to form a very slightly adhesive or non-adhesive film, which enables an element to be rolled up onto itself or several elements to be stacked together without requiring the use of an additional protective means. Moreover, as the film is only formed on the surface, it is capable of breaking under the effect of the pressure applied when the adhesive element is assembled on a substrate, thereby guaranteeing a perfect bond.

According to one particular characteristic, the pressure-sensitive adhesive will be applied to the substrate structure of the adhesive element in the form of at least one bead, or in the form of a pattern of dots, or else in the form of a thin fiberized bead deposited in a spiral or zig-zag pattern. Advantageously the pressure-sensitive adhesive is in the form of a foam.

According to another particular characteristic of the invention, the thickness of the pressure-sensitive adhesive will be between 0.2 and 10 mm, while the thickness of the very slightly adhesive or non-adhesive film mentioned above will be between 5 and 150 μm and preferably between 15 and 120 μm.

According to a second feature, the aim of the present patent application is to cover a process for the manufacture of an adhesive element, especially in the form of a strip or sheet, comprising a surface provided with a pressure-sensitive adhesive and designed to be assembled on a substrate by bonding, characterized in that it consists in:

applying said pressure-sensitive adhesive to at least part of said surface of said element, preferably in the form of a discontinuous layer; and

treating at least one portion of the surface of said adhesive which is not in contact with said element so as appreciably to reduce the adhesive capacity of said adhesive over part of the thickness of said portion(s), thereby defining a very slightly adhesive or non-adhesive film enabling said element to be rolled up or stacked with other adhesive elements without protection, said film being capable of being broken under the effect of the pressure applied when said element is assembled on a substrate.

### DETAILED DESCRIPTION

For reasons of clarity, the present invention will be described more particularly with reference to a currently preferred embodiment in which the adhesive element is in the form of a strip or sheet, for example a sealing panel for a motor vehicle.

The adhesive element according to the invention can of course take a variety of other forms.

As indicated previously, the adhesive element according to the invention, which will preferably be an adhesive strip or sheet, is covered, over at least part of its surface designed to be assembled on a substrate-forming element by bonding, with a layer of adhesive material, preferably deposited for example in the form of a bead, preferably of substantially circular cross-section, the free and accessible surface of said bead then undergoing a local treatment, preferably crosslinking, in order appreciably to reduce the adhesive capacity of this compound.

The base structure of the adhesive element according to the invention can be made of any type of material, for example paper, cardboard, plastic in the form of film or foam, metal, e.g. aluminum, a fabric, or else a composite formed by assembling layers of different materials.

In the case of sealing panels for motor vehicle doors, it is preferable to use foam sheets of certain plastics, which have the advantage of being leak-proof and thermoformable when the foam has a skin. It is thus possible to obtain three-dimensional thermoformed elements which perfectly match the complex structures of motor vehicle doors. In particular, foam sheets of non-crosslinked and flame-retarded polypropylene, having a skin on both sides, are used.

The adhesive materials which can be used within the framework of the present invention are preferably adhesive compositions formulated without a solvent by the so-called hot-melt process, in which the constituents are mixed at a temperature above their melting point and the composition obtained is deposited hot on the substrate structure of the element to be coated with adhesive.

Conventionally such adhesive compositions are formulated with:

elastomers which assure the cohesion of the adhesive mass,

resins which, in association with the elastomers and/or a plasticizer, make the adhesive mass sticky,

optionally plasticizers, and

stabilizers, for example antioxidants.

The adhesive masses formulated in this way are deposited hot on the substrate structure by means of an extrusion nozzle. This coating process has the advantage of being easy to carry out with the aid of a controlled robot which is capable of depositing the adhesive mass on the substrate structure, with good precision and good reproducibility, for example in the form of a bead or a pattern of dots. This process is very suitable for obtaining a discontinuous or partial coating on the substrate structure. This process also makes it possible to obtain a relatively thick coating, i.e. thicker than a customary coating covering the entire surface of the substrate with a low thickness generally of between 50 and 150 μm.

Within the framework of the currently preferred embodiment of the invention, apart from the customary constituents mentioned above, the adhesive compositions contain at least one constituent crosslinkable under the effect of an external agent, the crosslinking of which causes an appreciable reduction in the adhesive capacity of the compound. Examples of such constituents are crosslinkable tri-block elastomers of the SBS type such as the product marketed under the brand-name Kraton D KX222 by SHELL, which can crosslink by a free-radical process, or linear elastomers of the poly(ethylene/butylene) type marketed e.g. under the brand-name KLP-L207 by SHELL, which is crosslinkable by a cationic process. The crosslinking is then triggered by initiators, added to the formulation, which can be activated under the effect of ultraviolet (UV) irradiation.

It is also possible to use adhesive compositions containing acrylic-type copolymers which can be formulated under the action of heat without a solvent, by choosing in this case acrylic copolymers crosslinkable under UV irradiation. Such acrylic copolymers are marketed e.g. under the mark Acresin® A 258 UV or 203 UV by BASF and can be formulated in association with synthetic elastomers and a resin to give an adhesive compound whose surface adhesive capacity will be greatly reduced after crosslinking.

Among the other constituents of the adhesive composition, it is preferable to use so-called “tackifying” adhesive resins based on hydrogenated hydrocarbons, for example the resins REGALITE R 1090 or R 9100 marketed by HERCULES.

In practical terms an adhesive composition formulated under the action of heat may contain approximately:

20 to 35% of crosslinkable elastomer or polymer

0 to 20% of non-crosslinkable elastomer

45 to 65% of adhesive resin

0 to 15% of plasticizer

0.3 to 1.5% of antioxidant

0.3 to 1.5% of crosslinking initiator.

Each type of constituent can be a pure compound or a mixture of compounds having the requisite properties.

In practical terms, especially for application of the adhesive sheets designed for use in the motor vehicle sector, the adhesive mass used will be suitable for forming a foamed structure by the injection of nitrogen and will have a high adhesive capacity on both the sheet to be fixed and the painted sheet metal of the body. With this in mind, the preferred adhesive masses will have the following characteristics:

Brookfield viscosity at 160° C.: 30,000 to 50,000 mPa.s

Surface energy: 28 to 32 mJ/m²

polar component: 1 to 3 mJ/m²

Adhesive capacity on polypropylene foam

before crosslinking: >5 N/cm

after crosslinking: ≦1 N/cm

Adhesive capacity on painted sheet metal: >5 N/cm

The adhesive mass is generally formulated under the action of heat (140-160° C.) in a mixer by techniques known to those skilled in the art. The hot compound is then extruded, preferably in the form of a bead; in one preferred embodiment, said bead can be foamed by the injection of nitrogen to give a greater contact area and a reduced crush resistance for the same amount of adhesive mass.

The hot bead is extruded directly onto the sheet which it is desired to coat with adhesive. This operation is preferably carried out with the aid of a robot which deposits a uniform bead along a programmed trajectory, it being possible for said trajectory to be two- or three-dimensional according to whether the substrate sheet is flat or has thermoformed contours. In one advantageous embodiment, the foamed extruded adhesive is in the form of a bead with a diameter of between 1.5 and 10 mm.

Alternatively the adhesive mass can be applied to the sheet using the so-called fiberization coating technique, which consists in extruding a very thin bead, in the order of 0.2 to 1.5 mm in diameter, so as to cover between 5 and 50% of the zone of the sheet which it is desired to render adhesive.

The sheet, covered in this way with an adhesive bead over the fixing zones, is then subjected to a surface crosslinking treatment, for example under the effect of UV irradiation, which will activate the photoinitiators contained in the adhesive compound. In general, the operating conditions will be such that only the adhesive compound very close to the surface receiving the UV radiation is crosslinked, leaving the major part of the adhesive compound, at the center of the bead, non-crosslinked. In order essentially to crosslink that surface of the bead which will be exposed to the non-adhesive side of another sheet during storage in stacks, it is important for the UV radiation that initiates crosslinking to be directed preferably perpendicularly to the sheet carrying the adhesive.

Thus the process according to the invention makes it possible to obtain a sheet covered with a bead of adhesive mass, at least part of the free surface of which consists of a kind of very thin film or “crust” virtually devoid of adhesive capacity. Such sheets precoated with adhesive may thus be superimposed without the need to intercalate a non-stick sheet.

To fix an adhesive sheet according to the invention to a substrate, for example a motor vehicle body element, the adhesive side of the sheet is placed against the substrate and the bead of adhesive compound is then crushed by applying sufficient pressure to the non-adhesive side of the sheet: the crushing of the bead causes the crosslinked layer to break and establishes contact between the substrate and the non-crosslinked adhesive mass at the center of the bead.

The attached drawings will provide a better understanding of the invention.

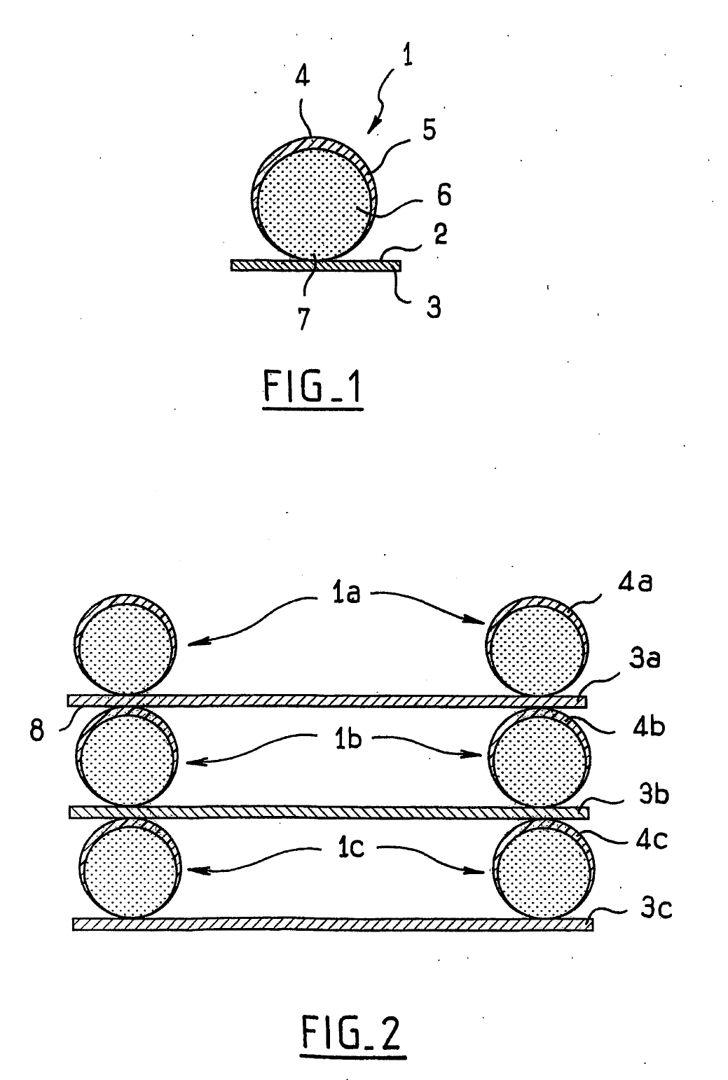

FIG. 1 is a cross-section of a bead of adhesive mass deposited on a sheet.

FIG. 2 is a cross-section of a stack of adhesive sheets each carrying a bead of adhesive around their periphery.

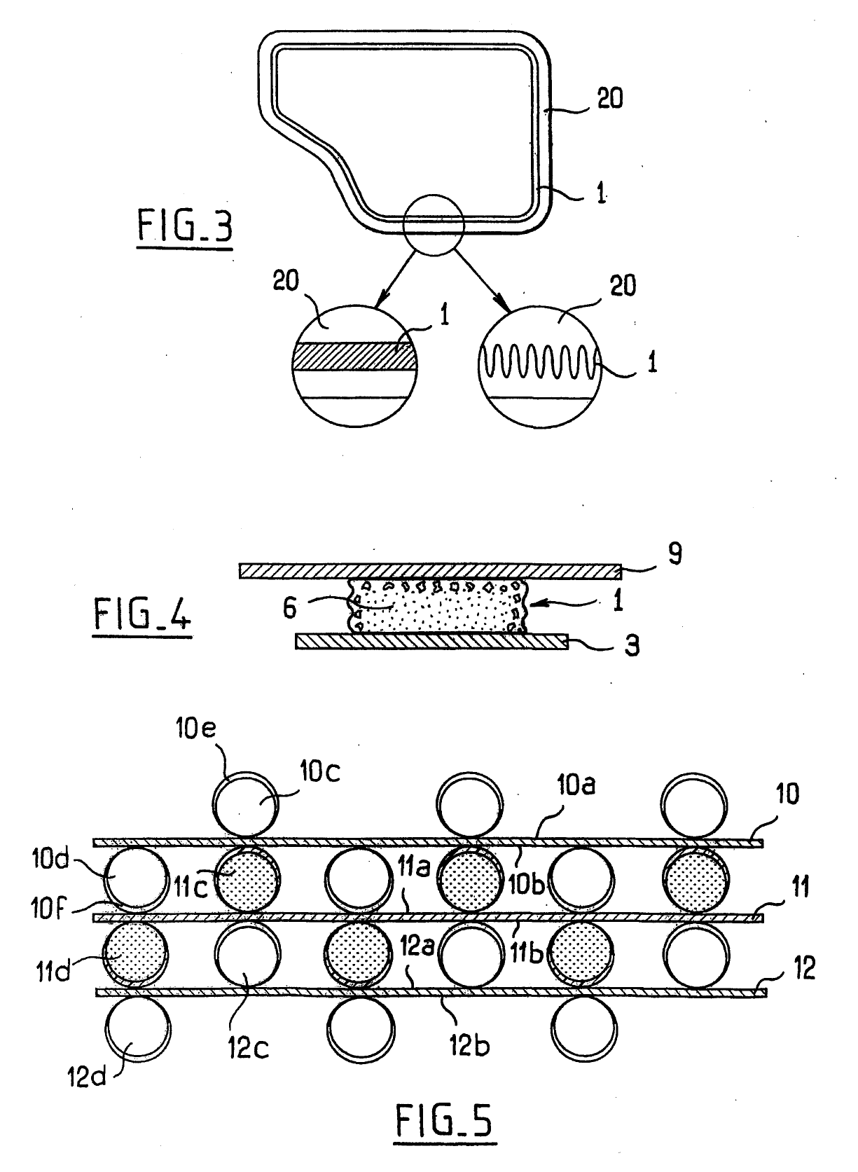

FIG. 3 is a top view of a panel carrying a bead of adhesive mass around its periphery, it being possible for said bead to be simple and parallel to the selvedge (FIG. 3a) or thin and fiberized (FIG. 3b) to cover a peripheral contact zone.

FIG. 4 is a cross-section of an adhesive sheet according to the invention after the bead has been crushed onto a substrate.

FIG. 5 is a section of an example of stacking in the case of sheets or a strip coated with adhesive on both sides by means of parallel beads of adhesive compound.

FIG. 1 is a section of a bead of adhesive compound 1 after the crosslinking operation by means of UV radiation diffused perpendicularly to the adhesive surface 2 of a sheet 3. The free surface 4 of the bead 1, and especially the upper part more exposed to the UV radiation, is crosslinked over a low thickness, in the order of 15 to 120 μm, and forms a kind of non-sticky film or crust 5 covering the non-crosslinked, inner adhesive mass 6. The part 7 of the bead 1 in contact with the sheet 3 cannot receive the UV radiation and does not undergo crosslinking.

FIG. 2 shows a stack of three adhesive sheets according to the invention. The free lower side 8 of the sheet 3a is in contact with the bead 1b of the sheet 3b situated below. The contact is established between the sheet 3a and the non-adhesive crosslinked surface 4b of the bead 1b. The two sheets can therefore be separated easily, at least for as long as the bead is not crushed under the effect of a substantial pressure. Similarly, the sheet 3b is in contact with the non-adhesive crosslinked surface 4c of the bead 1c deposited on the sheet 3c.

FIG. 3 shows a practical example such as a sealing panel of a motor vehicle door, 20, which can be fixed to the body structure by means of an adhesive bead according to the invention, said bead being deposited around the periphery of the panel, either in conventional manner, as in FIG. 3a, or by the so-called fiberization technique, as in FIG. 3b, which uses a bead of very small diameter applied in a spiral or zig-zag pattern to the surface which is to be coated with adhesive.

FIG. 4 is a cross-section of the bead 1 deposited on the substrate sheet 3, after it has been crushed by another substrate 9: the crosslinked surface film 5 has been broken and the sticky adhesive mass 6 establishes contact between the substrate 9 and the sheet 3 and joins them together.

FIG. 5 shows several substrate sheets 10, 11, 12 capable of being stacked on top of one another without the intercalation of a non-stick separator. The sheet 10 is provided on both sides, 10a and 10b, with at least one bead 10c, 10d, whose outer surface 10e, 10f has been crosslinked in the manner indicated above in respect of FIGS. 1 and 2 in particular. The beads 11c deposited on the upper side 11a of the sheet 11 are intercalated between the beads 10d of the sheet 10, while the beads 11d deposited on the side 11b of the sheet 11 are intercalated between the beads 12c deposited on the side 12a of the sheet 12, which can be provided on its lower side 12b with beads 12d. Of course, the outer surfaces of the beads 11c, 11d, 12c and 12d are also crosslinked so that they do not adhere, or only adhere very slightly, to the opposing sides of the superimposed sheets.

It is obvious that, instead of a bead of adhesive mass, it is possible to use a pattern of dots of adhesive compound appropriately distributed over the surface of the substrate sheet on which they are deposited.

The practical example below, which is given without implying a limitation, relates to a sealing panel for a car door, said panel being designed to be fixed in leak-proof manner to the painted metal structure of the door.

An adhesive mass is prepared by mixing the following in a mixer at 160° C.: 30 kg of paraffin oil (ONDINA® 68 supplied by SHELL), 3 kg of antioxidant (IRGANOX 1010 obtained from CIBA-GEIGY), 28.5 kg of styrene/isoprene/styrene tri-block elastomer containing about 21% of styrene blocks (Kraton D 1111 obtained from SHELL), 14.3 kg of styrene/isoprene/styrene tri-block elastomer containing about 25% of styrene blocks (SOLT 193B obtained from ENI CHEM) and 57.2 kg of crosslinkable styrene/butadiene/styrene tri-block elastomer (Kraton D KX222C obtained from SHELL). When the mixture is homogeneous, 150 kg of resin based on hydrogenated hydrocarbons (Regalite R1090 supplied by HERCULES) are added, followed by 3 kg of free-radical photoinitiator (IRGACURE® 651 supplied by CIBA-GEIGY).

The adhesive mass formulated in this way is deposited hot in the form of a nitrogen-foamed bead on a polypropylene foam sheet treated by the CORONA process on the side receiving the adhesive. The bead is foamed so as to contain about 50% of gas, and has a diameter of about 6 mm. The sheet thus coated with adhesive on its upper side then passes under UV lamps developing a power of 120 W/cm: the radiation causes the surface of the bead to crosslink over a thickness of about 40 to 100 μm, said surface thereby experiencing a drop in adhesive capacity from 6.4 to 0.9 N/cm. The resulting sheets can be stacked without the need to intercalate a non-stick protector.

Such sealing panels are placed on the door structure in a manner that is virtually analogous to the customary procedure: the panel is placed in position and the bead (which may be visible through the panel if the latter is translucent) is then crushed over its entire length with the aid of a roller. The sticky adhesive compound assures a leak-proof bond between the sheet and the substrate structure.

A second practical example used the following constituents:

elastomer: Kraton D 1111: 66.7 kg Solt T 193B: 33.3 kg

resin: Regalite R1090: 150 kg

crosslinkable acrylic resin: Acresin® A 258 UV (BASF): 60 kg

plasticizer: ONDINA® 68: 30 kg

antioxidant: IRGANOX 1010: 3 kg

The adhesive mass obtained, which is applied and crosslinked under conditions analogous to those described for the previous example, gives substantially identical results.

Other crosslinkable elastomers can be used within the framework of the present invention, examples being the crosslinkable liquid tri-block elastomers obtainable from SHELL under the references KLP L 207 and KLP L 1203, which have to be formulated with a cationic crosslinking photoinitiator.

These formulation examples and the application examples described in order to illustrate the invention must not be considered as implying a limitation. Thus, for example, the adhesive strip or sheet can be in the form of a tape rolled up onto itself without protection, the entire width of one side being covered with adhesive mass deposited by fiberization.

It is also possible to obtain sheets coated with adhesive on both sides by means of beads of adhesive mass crosslinked on the surface, preferably taking care to ensure that the adhesive parts of the opposing sides are alternated in the stack, as shown in FIG. 5, where the adhesive beads of the sheet 10 are opposite non-adhesive zones of the sheet 11.

The invention also applies to the production of a double-sided adhesive obtained by coating the strands of a polyester web (marketed e.g. by TEXINOV under the reference 355) serving as a substrate in the form of a mesh, leaving the apertures open. The adhesive material, crosslinked on both sides, releases its adhesive capacity only after the material has been crushed between the two objects to be assembled.

The present invention affords numerous advantages.

Thus the adhesive strips or sheets according to the invention allow the use of a composition of high adhesive capacity without the need to use the non-stick protectors that give rise to expensive and bulky waste. The result is a substantial saving of working time because the operation of removing the protector is eliminated. Moreover, the positioning of the adhesive sheet is easy and precise. In fact, as the fixture only becomes definitive after the bead has been crushed, it is possible to position the sheet precisely without being hampered by part of the adhesive zone sticking prematurely.

Thus the large difference in adhesive capacity before and after the bead with a crosslinked surface is crushed enables a precoated object to be assembled on a substrate in a novel manner which was previously impossible.

This positioning process consists essentially in:

a/ placing the object, pre-coated with adhesive, on the receiving substrate and fixing it without pressing hard, so as to obtain a weak and repositionable fixture,

b/ checking the correct positioning of the object on the substrate,

c/ if necessary, correcting the position of the object on the substrate, and

d/ fixing the precoated object firmly to the substrate by applying substantial pressure to the parts of the object coated with adhesive.

The resulting fixture is particularly effective and makes it impossible to separate the object from its substrate without destroying at least one of the object/adhesive/substrate elements.

The invention is mainly applied in the sectors of industry that require fixing or sealing adhesives: fixing of sealing panels, shutters and cables in motor vehicles, and fixing of cables or joints in buildings. The invention also applies to the do-it-yourself sector for producing joints or fixtures normally effected with adhesive tape or accessories precoated with adhesive, for example joints, hooks, decorative strips or molding trim for electric wires.

1. Adhesive element, especially in the form of a strip or sheet (3), comprising a surface (2) provided with a pressure-sensitive adhesive and designed to be assembled on a substrate by bonding, characterized in that said adhesive is present over at least part of said surface (2), preferably in the form of a discontinuous layer, and in that it has a reduced adhesive capacity over part of the thickness of at least one portion of its free surface (4), defining a very slightly adhesive or non-adhesive film (5) enabling said element to be rolled up or stacked with other adhesive elements without protection, said film (5) also being capable of being broken under the effect of the pressure applied when said element is assembled to a substrate.

2. Adhesive element according to claim 1, characterized in that the very slightly adhesive or non-adhesive film (5) mentioned above is obtained by a surface crosslinking treatment of said pressure-sensitive adhesive, preferably a photoinduced crosslinking treatment.

3. Adhesive element according to claim 1 or 2, characterized in that the above-mentioned pressure-sensitive adhesive is in the form of at least one bead.

4. Adhesive element according to claim 1 or 2, characterized in that the above-mentioned pressure-sensitive adhesive is in the form of a pattern of dots.

5. Adhesive element according to claim 1 or 2, characterized in that the above-mentioned pressure-sensitive adhesive is in the form of a thin fiberized bead deposited in a spiral or zig-zag pattern.

6. Adhesive element according to one of claims 1 to 5, characterized in that the above-mentioned pressure-sensitive adhesive is in the form of a foam.

7. Adhesive element according to one of claims 1 to 6, characterized in that the above-mentioned pressure-sensitive adhesive has a thickness of between 0.2 and 10 mm.

8. Adhesive element according to one of claims 1 to 7, characterized in that the preferably crosslinked film (5) mentioned above has a thickness of between 5 and 150 μm and preferably of between 15 and 120 μm.

9. Adhesive element according to one of claims 1 to 8, characterized in that it is in the form of a strip or sheet, each side of which (10a, 10b; 11a, 11b; 12a, 12b) carries beads or a pattern of dots (10c, 10d; 11c, 11d; 12c, 12d) arranged so that said beads or a pattern of dots on one side are intercalated between the beads or a pattern of dots of the consecutive sheet or strip, thereby enabling strips or sheets to be stacked without the intercalation of a protector.

10. Adhesive element according to one of claims 1 to 9, characterized in that it is in the form of an adhesive foam sheet of thermoformable non-crosslinked propylene.

11. Process for the manufacture of an adhesive element, especially in the form of a strip or sheet (3), comprising a surface (2) provided with a pressure-sensitive adhesive and designed to be assembled to a substrate by bonding, characterized in that it consists in:
applying said pressure-sensitive adhesive over at least part of said surface (2) of said element, preferably in the form of a discontinuous layer; and
treating at least one portion of the surface (4) of said adhesive which is not in contact with said element so as appreciably to reduce the adhesive capacity of said adhesive over part of the thickness of said portion(s), thereby defining a very slightly adhesive or non-adhesive film enabling said element to be rolled up or stacked with other adhesive elements without protection, said film being capable of being broken under the effect of the pressure applied when said element is assembled to a substrate.

12. Process according to claim 11, characterized in that the above-mentioned treatment is a surface crosslinking treatment of said pressure-sensitive adhesive, preferably a photoinduced crosslinking treatment.

13. Process according to claim 11 or 12, characterized in that the above-mentioned pressure-sensitive adhesive is applied in the form of at least one bead.

14. Process according to claim 11 or 12, characterized in that the above-mentioned pressure-sensitive adhesive is applied in the form of a pattern of dots.

15. Process according to claim 11 or 12, characterized in that the above-mentioned pressure-sensitive adhesive is applied in the form of a thin fiberized bead deposited in a spiral or zig-zag pattern.

16. Process according to one of claims 11 to 15, characterized in that the above-mentioned pressure-sensitive adhesive is applied in the form of a foam.

17. Process according to one of claims 11 to 16, characterized in that the above-mentioned pressure-sensitive adhesive is applied in a thickness of between 0.2 and 10 mm.

18. Process according to one of claims 11 to 17, characterized in that the above-mentioned pressure-sensitive adhesive is treated under conditions suitable for obtaining a preferably crosslinked film whose thickness is between 5 and 150 μm and preferably between 15 and 120 μm.
